(19) United States
(12) Patent Application Publication
(10) Pub. No.: US 2011/0149000 A1
(43) Pub. Date: Jun. 23, 2011

(54) INKJET PRINTHEAD MODULE WITH ADJUSTABLE ALIGNMENT

(75) Inventors: David ALBERTALLI, Santa Clara, CA (US); James N. MIDDLETON, Brentwood, CA (US); Roy M. Patterson, Pflugerville, TX (US)

(73) Assignee: ULVAC, INC., Kanagawa (JP)

(21) Appl. No.: 12/975,922

(22) Filed: Dec. 22, 2010

Related U.S. Application Data
(60) Provisional application No. 61/289,702, filed on Dec. 23, 2009.

(51) Int. Cl. B41J 2/18; B05B 1/02; B05B 15/08; B05B 15/10; B05C 13/00

(52) U.S. Cl. 347/89; 118/315; 118/712; 118/713; 118/663; 118/696

(57) ABSTRACT

A microdeposition system includes a stage, a printhead carriage, and a controller. The stage holds a substrate. The printhead carriage includes N printhead modules, where N is an integer greater than one. Each of the N printhead modules includes a printhead and an alignment mechanism. The printhead includes a plurality of nozzles that deposit droplets of fluid manufacturing material onto the substrate while relative movement between the substrate and the printhead is along a first axis. The alignment mechanism adjusts the printhead with respect to the printhead module. The controller controls the alignment mechanisms of the N printhead modules to set effective nozzle spacing for the pluralities of nozzles to a uniform value. The effective nozzle spacing is defined as spacing between adjacent ones of the plurality of nozzles as projected onto a second axis perpendicular to the first axis.

### CROSS-REFERENCE TO RELATED APPLICATIONS

This application claims the benefit of U.S. Provisional Application No. 61/289,702, filed on Dec. 23, 2009. The disclosure of the above application is incorporated herein by reference in its entirety.

### FIELD

The present disclosure relates to inkjet printing and more particularly to method and apparatus for adjusting nozzle alignment of an inkjet printhead module.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Manufacturers have developed various techniques for fabricating microstructures that have small feature sizes. The microstructures may form one of more layers of an electronic circuit. Examples of these structures include light-emitting diode (LED) display devices, polymer LED (PLED) display devices, organic LED (OLED) devices, liquid crystal display (LCD) devices, and printed circuit boards. Many of these manufacturing techniques are relatively expensive to implement and require high production quantities to amortize the cost of the fabrication equipment.

One technique for forming microstructures on a substrate is screen printing. During screen printing, a fine mesh screen is positioned on the substrate. Fluid material is deposited through the screen and onto the substrate in a pattern defined by the screen. Screen printing therefore causes contact between the screen and the substrate. Contact also occurs between the screen and the fluid material, which contaminates both the substrate and the fluid material.

While screen printing is suitable for forming some microstructures, many manufacturing processes do not allow contamination of the substrate by the screen. Therefore, screen printing is not a viable option for the manufacture of certain microstructures. For example, polymer light-emitting diode (PLED) display devices may require a contamination-free manufacturing process.

Certain polymeric substances can be used to manufacture diodes that generate visible light of different wavelengths. Using these polymers, display devices having pixels with sub-components of red, green, and blue can be created. PLED fluid materials enable full-spectrum color displays and require very little power to emit a substantial amount of light. PLED displays can be used in various applications, including televisions, computer monitors, PDAs, other handheld computing devices, cellular phones, etc. PLED technology may also be used for manufacturing light-emitting panels that provide ambient lighting for office, storage, and living spaces. One obstacle to the widespread use of PLED display devices is the difficulty and expense of manufacturing PLED display devices.

Photolithography is another manufacturing technique that is used to manufacture microstructures on substrates. Photolithography may also be incompatible with PLED display devices. Manufacturing processes using photolithography generally involve the deposition of a photoresist material onto a substrate. The photoresist material is cured by exposure to light. A patterned mask is therefore used to selectively apply light to the photoresist material. Photoresist that is exposed to the light is cured and unexposed portions are not cured. The uncured portions can be removed from the substrate while the cured portions remain.

An underlying surface of the substrate is exposed through the removed photoresist layer. Another material is then deposited onto the substrate through the opened pattern on the photoresist layer, followed by the removal of the cured portion of the photoresist layer.

Photolithography has been used successfully to manufacture many microstructures, such as traces on circuit boards. However, photolithography contaminates the substrate and the material formed on the substrate. Photolithography may not be compatible with the manufacture of PLED displays because the photoresist contaminates the PLED polymers. In addition, photolithography involves multiple steps for applying and processing the photoresist material. The cost of the photolithography process can be prohibitive when relatively small quantities are to be fabricated. Further, expensive PLED material may be lost when it is deposited on cured photoresist that is later removed.

Spin coating has also been used to form microstructures. Spin coating involves rotating a substrate while depositing fluid material at the center of the substrate. The rotational motion of the substrate causes the fluid material to spread evenly across the surface of the substrate. Spin coating is also an expensive process because a majority of the fluid material does not remain on the substrate. In addition, the size of the substrate is limited by the spin coating process to less than approximately 12″, which makes spin coating unsuitable for larger devices such as PLED televisions.

### SUMMARY

A microdeposition system includes a printhead carriage, a stage, and a controller. The printhead carriage includes N printhead modules and moves along an x axis. N is an integer greater than one. The stage holds a substrate beneath the printhead carriage and moves the substrate along a y axis perpendicular to the x axis. Each of the N printhead modules includes a fixed bracket a rotating bracket, first, second, and third actuators, a printhead bracket, and a printhead. The fixed bracket is rigidly mounted to the printhead carriage. The rotating bracket is rotatably and slidably coupled to the fixed bracket.

The rotating bracket rotates about a z axis perpendicular to a horizontal plane parallel to the x and y axes, and slides along the z axis. The first actuator rotates the rotating bracket with respect to the fixed bracket. The second actuator slides the rotating bracket relative to the fixed bracket. The printhead bracket is slidably coupled to the rotating bracket. The printhead bracket slides along the x axis when the rotating bracket is parallel to the x axis. The third actuator slides the printhead bracket relative to the rotating bracket. The printhead is rigidly attached to the printhead bracket. The printhead includes a plurality of nozzles separated from each other by a physical nozzle spacing and arranged along a line parallel to the horizontal plane. The plurality of nozzles deposit droplets of fluid material onto the substrate.

The controller controls the first actuator of each of the N printhead modules to set an effective nozzle spacing of the N printhead modules to a common spacing value. The effective nozzle spacing is defined by spacing between positions of the plurality of nozzles as projected onto the x axis. The controller selectively adjusts the third actuator of first and second printhead modules of the N printhead modules such that an effective spacing between a last nozzle of the first printhead module and a first nozzle of the second printhead module, with respect to the x axis, is equal to the common spacing value. The common spacing value is determined based on a minimum one of the physical nozzle spacings of the N printhead modules. The controller controls the second actuator of each of the N printhead modules to set a vertical position of each of the N printhead modules to a common vertical value. The printhead carriage includes a turntable that holds the N printhead modules. The turntable rotates with respect to the printhead carriage about the z axis.

A microdeposition system includes a stage, a printhead carriage, and a controller. The stage holds a substrate. The printhead carriage includes N printhead modules. N is an integer greater than one. Each of the N printhead modules includes a printhead and an alignment mechanism. The printhead includes a plurality of nozzles that deposit droplets of fluid manufacturing material onto the substrate while relative movement between the substrate and the printhead is along a first axis. The alignment mechanism adjusts the printhead with respect to the printhead module. The controller controls the alignment mechanisms of the N printhead modules to set effective nozzle spacing for the pluralities of nozzles to a uniform value. The effective nozzle spacing is defined as spacing between adjacent ones of the plurality of nozzles as projected onto a second axis perpendicular to the first axis.

In other features, the stage moves the substrate along the first axis during deposition of the droplets of fluid manufacturing material. The printhead carriage translates to new positions along the second axis between passes of the substrate. For each of the N printhead modules, the plurality of nozzles are separated by a physical nozzle spacing. The controller determines the uniform value based on the physical nozzle spacings of the N printhead modules. The controller determines the uniform value based on a smallest one of the physical nozzle spacings of the N printhead modules.

In further features, the microdeposition system further includes a camera facing toward the printhead carriage along a third axis perpendicular to the first and second axes. The controller determines the physical nozzle spacing of each of the N printhead modules based on information from the camera. The controller controls the alignment mechanism of one of the N printhead modules to set the effective nozzle spacing for the plurality of nozzles of the one of the N printhead modules to the uniform value.

In other features, the alignment mechanism of the one of the N printhead modules includes a fixed bracket mounted to the printhead carriage, a rotating bracket rotatably coupled to the fixed bracket, and an actuator. The printhead is coupled to the rotating bracket. Based on control from the controller, the actuator rotates the rotating bracket about a third axis perpendicular to the first and second axes. The controller controls the alignment mechanisms of first and second adjacent printhead modules of the N printhead modules to set the effective nozzle spacing between a last nozzle of the first adjacent printhead module and a first nozzle of the second adjacent printhead module to the uniform value.

In further features, the N printhead modules are arranged in a plurality of rows that are parallel to the second axis. The first adjacent printhead module is in a first one of the plurality of rows. The second adjacent printhead module is in a second one of the plurality of rows. The alignment mechanism of the second adjacent one of the N printhead modules includes a bracket coupled to the printhead carriage, a printhead assembly slidably coupled to the bracket, and an actuator. The printhead is mounted to the printhead assembly. The printhead assembly slides along the second axis when the bracket is parallel to the second axis. Based on control from the controller, the actuator slides the printhead assembly with respect to the bracket.

In other features, for each of the N printhead modules, the alignment mechanism adjusts the printhead along a third axis perpendicular to the first and second axes. The controller sets a spacing between the printhead and the stage to a common height for each of the N printhead modules. The microdeposition system includes a camera facing toward the printhead carriage along the third axis. The controller controls the alignment mechanism of the N printhead modules based on a focal length measurement of the respective one of the N printhead modules by the camera.

The alignment mechanism of one of the N printhead modules includes a fixed bracket mounted to the printhead carriage, a second bracket slidably coupled to the fixed bracket along the third axis, and an actuator. The printhead is coupled to the second bracket. Based on control from the controller, the actuator slides the second bracket with respect to the fixed bracket.

In further features, the alignment mechanism for one of the N printhead modules includes a fixed bracket mounted to the printhead carriage, a rotating bracket rotatably coupled to the fixed bracket, and a first actuator that rotates the rotating bracket relative to the fixed bracket. The rotating bracket rotates about a third axis perpendicular to the first and second axes. The printhead is coupled to the rotating bracket.

In other features, the printhead is slidably coupled to the rotating bracket. The printhead slides along the second axis when the rotating bracket is parallel to the second axis. The alignment mechanism for one of the N printhead modules further includes a second actuator that slides the printhead with respect to the rotating bracket. The rotating bracket is slidably coupled to the fixed bracket. The alignment mechanism for one of the N printhead modules further includes a third actuator that slides the rotating bracket along the third axis with respect to the fixed bracket.

In further features, the printhead carriage includes a turntable that holds the N printhead modules. The turntable rotates with respect to the printhead carriage about a third axis perpendicular to the first and second axes. The controller performs a calibration routine to set the effective nozzle spacing for the pluralities of nozzles to the uniform value before depositing the droplets of fluid manufacturing material onto the substrate has begun.

A printhead module includes a printhead including a plurality of nozzles that deposit droplets of fluid manufacturing material onto a substrate, a head manifold that distributes the fluid manufacturing material to the plurality of nozzles and that includes a supply port and a return port, and a fluid distribution system that connects to the supply port and the return port. The fluid distribution system includes a pressure port that receives one of a pressure and a vacuum and a reservoir having a cylindrical shape with a tapered bottom portion, wherein the pressure port applies the one of the pressure and the vacuum to a top of the reservoir. The fluid distribution system also includes an ink port that receives one of the fluid manufacturing material and a solvent, a refill valve that selectively connects the ink port to the reservoir, fluid sensors that measure levels of fluid in the reservoir, and a control module that controls the refill valve based on the measured levels of fluid.

The fluid distribution system also includes a recirculation port that returns unused amounts of the fluid manufacturing material to an external fluid supply, a bypass valve that alternately connects the reservoir to a common fluid node and to the recirculation port, a solvent port that receives the solvent, and a solvent valve that selectively connects the solvent port to the common fluid node. The fluid distribution system also includes an ink valve that selectively connects the common fluid node to the supply port, a removable filter assembly interposed between the ink valve and the supply port, a waste port, and a return valve that selectively connects the return port to the waste port.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an isometric view of an example microdeposition system;

FIG. 2 is a simplified top view of an example microdeposition system;

FIG. 3A is a simplified side view of an example printhead module;

FIG. 3B depicts nozzle plate rotation to achieve a desired uniform pitch;

FIG. 3C depicts alignment between head packs along the x axis;

FIGS. 4-6 are isometric views of an example printhead module;

FIG. 7 is an exploded view of alignment components of the printhead module;

FIG. 8 is another isometric view of the printhead module;

FIG. 9 is a functional block diagram of example fluid routing in the printhead module;

FIG. 10 is a partial cutaway view of the printhead module to show fluid components;

FIG. 11 is an exploded view of the printhead module;

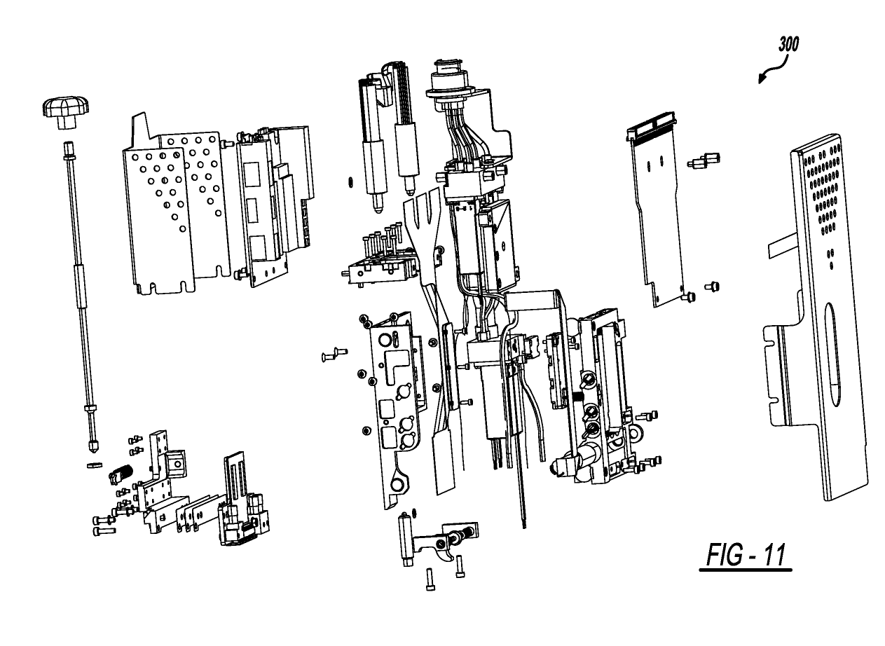

FIG. 12 is a side view of the printhead module;

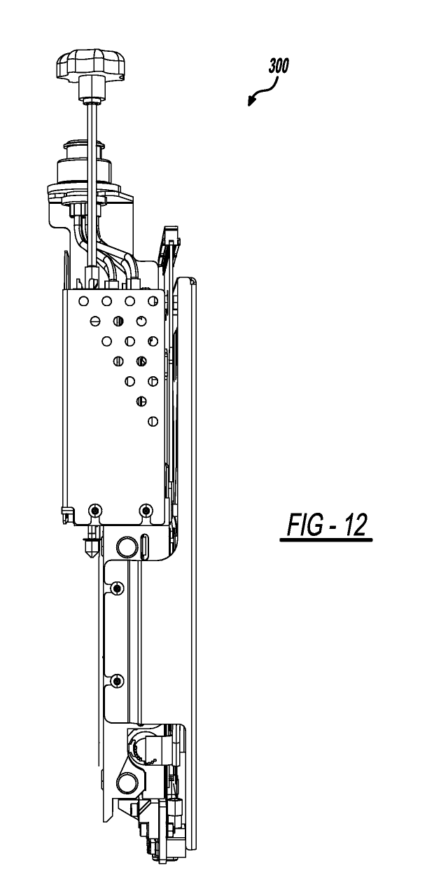

FIG. 13 is a front view of the printhead module; and

FIG. 14 is a rear view of the printhead module.

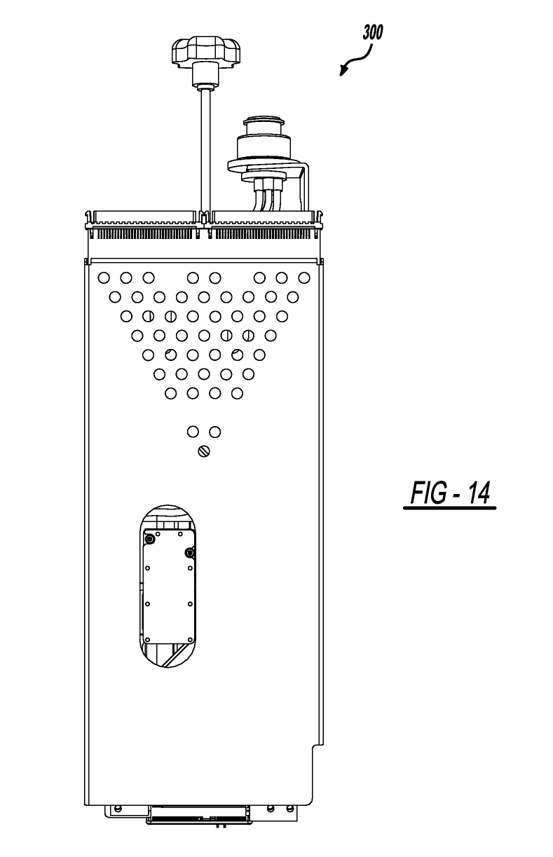

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

The terms “fluid manufacturing material” and “fluid material,” as defined herein, are broadly construed to include any material that can assume a low viscosity form and that is suitable for being deposited, for example, from a microdeposition head onto a substrate for forming a microstructure. Fluid manufacturing materials may include, but are not limited to, light-emitting polymers (LEPs), which can be used to form polymer light-emitting diode display devices (PLEDs and PolyLEDs). Fluid manufacturing materials may also include plastics, metals, waxes, solders, solder pastes, biomedical products, acids, photoresists, solvents, adhesives, and epoxies. The term “fluid manufacturing material” is interchangeably referred to herein as “fluid material.”

The term “deposition,” as defined herein, generally refers to the process of depositing individual droplets of fluid materials on substrates. The terms “let,” “discharge,” “pattern,” and “deposit” are used interchangeably herein with specific reference to the deposition of the fluid material from a microdeposition head, for example. The terms “droplet” and “drop” are also used interchangeably.

The term “substrate,” as defined herein, is broadly construed to include any material having a surface that is suitable for receiving a fluid material during a manufacturing process such as microdeposition. Substrates include, but are not limited to, glass plate, pipettes, silicon wafers, ceramic tiles, FR-4 and other printed circuit board materials, rigid and flexible plastic, and metal sheets and rolls. In certain embodiments, a deposited fluid material itself may form a substrate, as the fluid material itself also includes surfaces suitable for receiving a fluid material during manufacturing, such as, for example, when forming three-dimensional microstructures.

The term “microstructures,” as defined herein, generally refers to structures formed with a high degree of precision, and that are sized to fit on a substrate. Because the sizes of different substrates may vary, the term “microstructures” should not be construed to be limited to any particular size and can be used interchangeably with the term “structure.” Microstructures may include a single droplet of a fluid material, any combination of droplets, or any structure formed by depositing the droplet(s) on a substrate, such as a two-dimensional layer, a three-dimensional architecture, and any other desired structure.

The microdeposition systems referenced herein perform processes by depositing fluid materials onto substrates according to user-defined computer-executable instructions. The term “computer-executable instructions,” which is also referred to herein as “program modules” or “modules,” generally includes routines, programs, objects, components, data structures, or the like that implement particular abstract data types or perform particular tasks such as, but not limited to, executing computer numerical controls for implementing microdeposition processes.

Program modules may be stored on any non-transitory, tangible computer-readable media, including, but not limited to RAM, ROM, EEPROM, CD-ROM or other optical disk storage, magnetic disk storage or other magnetic storage devices, or any other medium capable of storing instructions or data structures and capable of being accessed by a general purpose or special purpose computer.

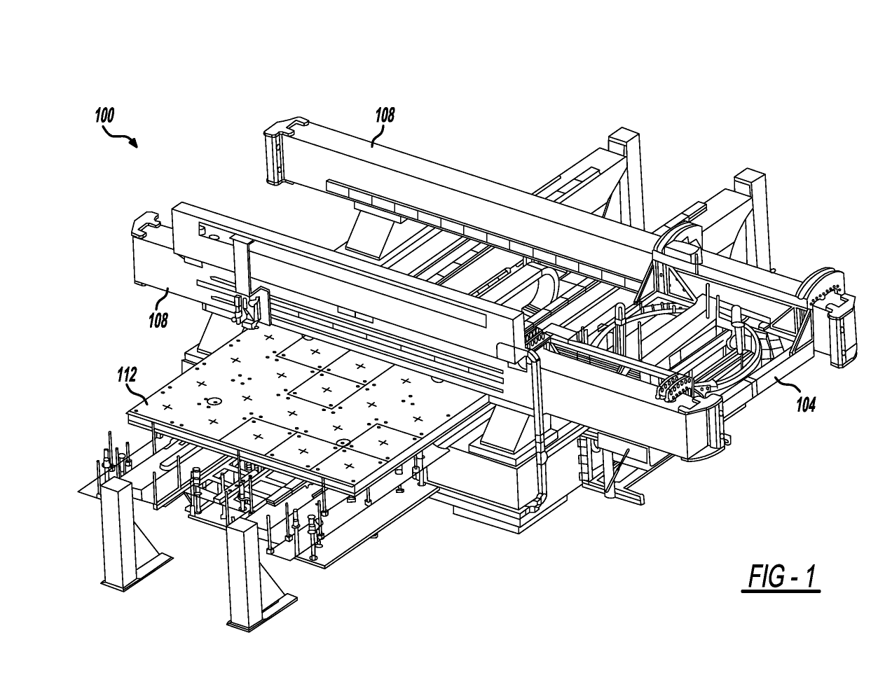

Referring now to FIG. 1, a microdeposition system 100 includes a printhead carriage 104 that slides along beams 108. For example only, the beams 108 may be constructed from granite. The direction of travel of the printhead carriage 104 is referred to as the x axis. The printhead carriage 104 includes one or more rows of nozzles that deposit a fluid manufacturing material on a substrate 112. For example only, the substrate 112 may be a sheet of glass and may be a component of a PLED video monitor or television.

The substrate 112 may be secured by a chuck, which may hold the substrate 112 using a vacuum. The substrate 112 may translate back and forth along the y axis, which is perpendicular to the x axis. For example only, the printhead carriage 104 may align the rows of nozzles to be parallel to the x axis. As the substrate 112 moves along the y axis, the rows of nozzles selectively deposit fluid manufacturing material onto the substrate 112. The rows of nozzles may be unable to cover the entire substrate 112 in one pass. The printhead carriage 104 may therefore translate to another position along the x axis. The substrate 112 will then move back along the y axis to print the next pass.

Alternatively, the printhead carriage 104 may print while moving along the x axis, with the substrate 112 remaining stationary. The substrate 112 would then translate to a new position along the y axis after each pass is completed. The nozzles in the printhead carriage 104 may be periodically maintained to ensure uniform dispensing of droplets. In various implementations, nozzle maintenance may be performed when the substrate 112 is being loaded into the system 100 and/or when the substrate 112 is being unloaded from the system 100.

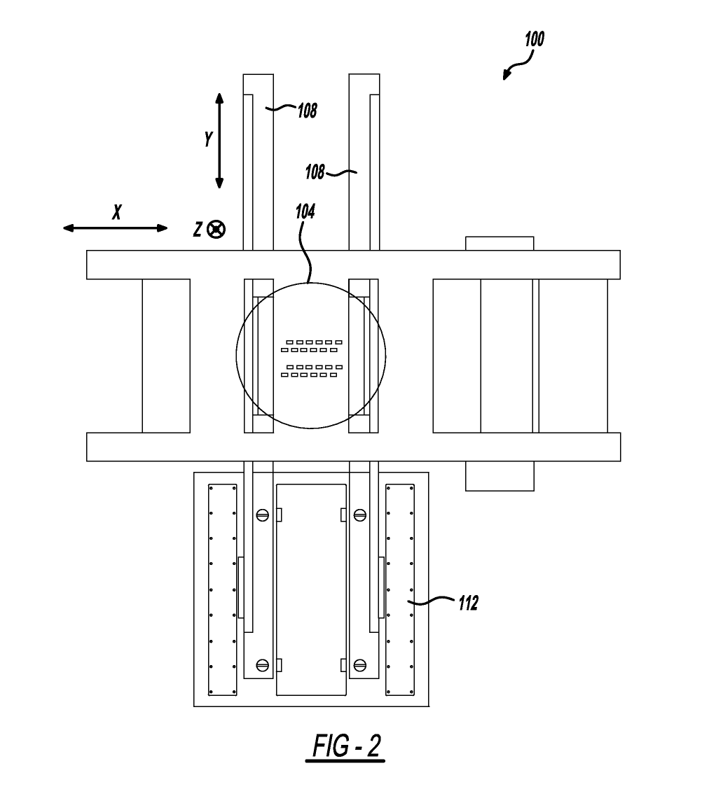

Referring now to FIG. 2, the printhead carriage 104 is depicted as having four rows of white rectangles, where each white rectangle graphically represents a printhead module. Each printhead module may include multiple nozzles, such as 128 nozzles. Therefore, the example of FIG. 2 includes four rows of six printhead modules each having 128 nozzles, for a total of 3072 nozzles.

Each row of printhead modules may be connected to a common pack mounting block and referred to as a pack. The nozzles of each pack may be generally colinear. In various implementations, the nozzles selectively eject droplets of fluid manufacturing material as the substrate 112 translates along the y axis. After printing one pass, the printhead carriage 104 translates into the next position along the x axis, and the substrate 112 traverses the printhead carriage 104 in the other direction along the y axis.

In order to achieve finer resolution, the packs can be rotated as a group by the printhead carriage 104. By rotating the packs, the nozzles are more closely spaced in terms of their x coordinates. For example, if two adjacent nozzles were to continuously disperse droplets, two parallel lines would be created on the substrate 112. These lines are closer together as the head packs are rotated away from an orientation parallel to the x axis.

In various implementations, the packs may be slid in the x-y plane with respect to each other while keeping the rows of nozzles of each pack parallel. This may allow for more consistent coverage of the substrate 112 when the printhead carriage 104 rotates the packs.

When the packs are rotated, printing a line parallel to the x axis on the substrate 112 requires staggering the firing of the angled nozzles. Nozzle firing times may therefore be based on the angle of the packs.

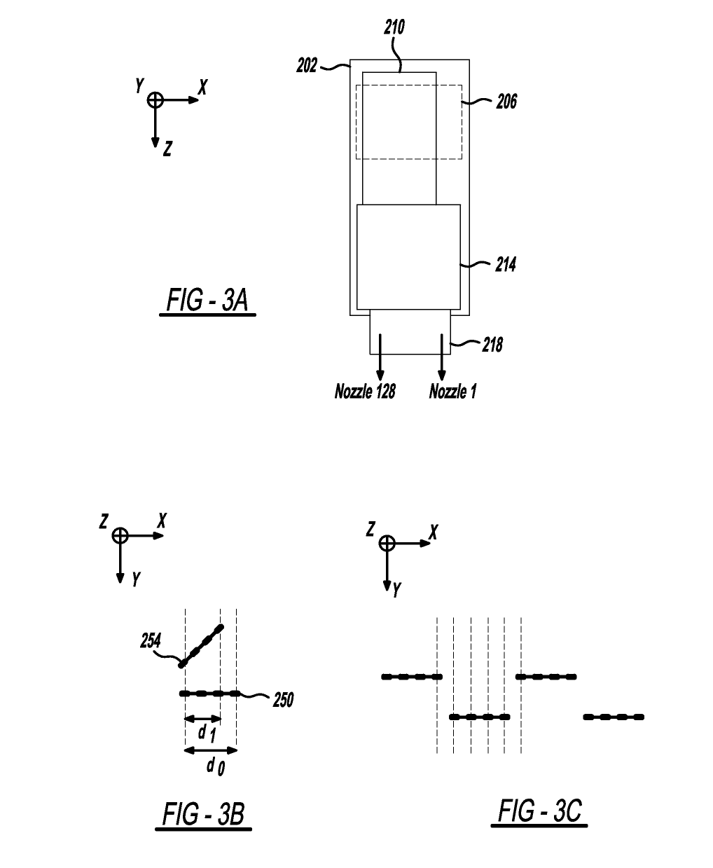

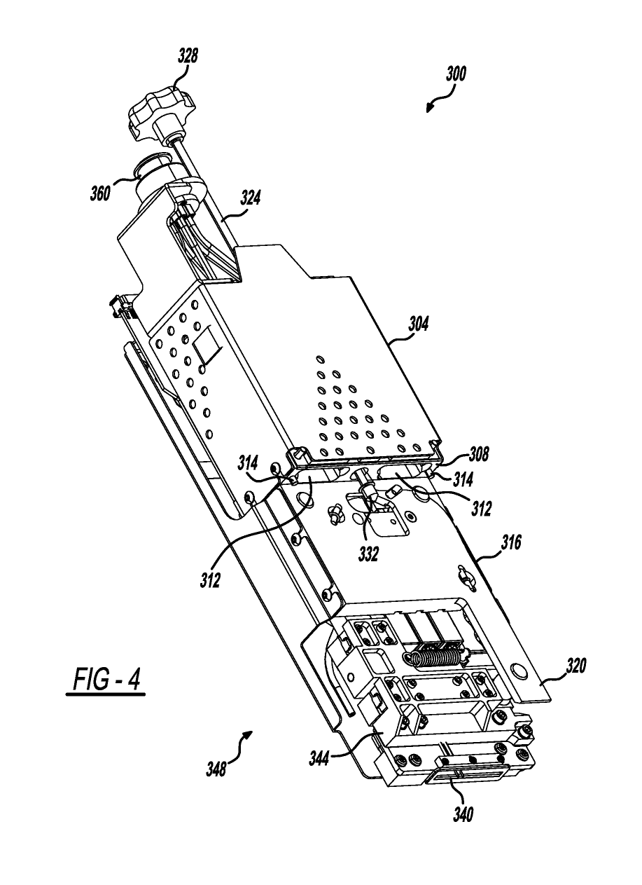

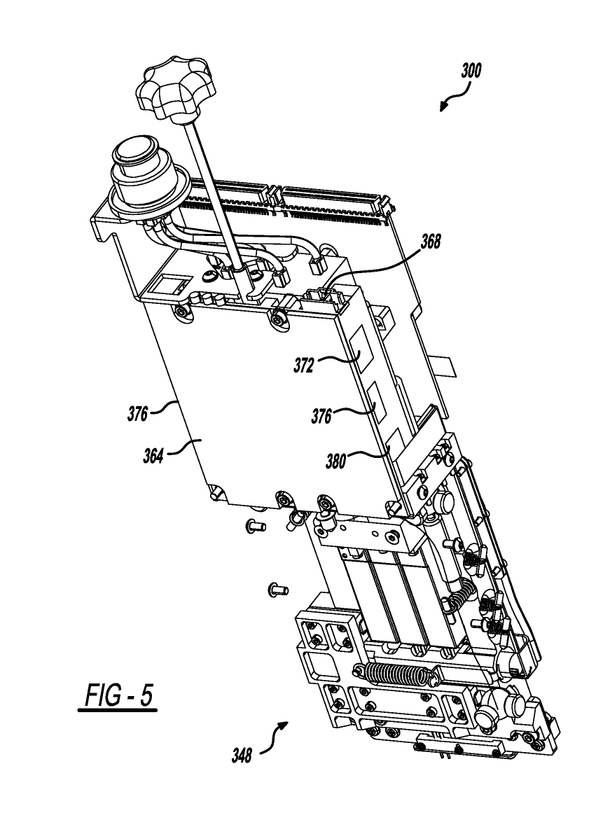

Referring now to FIG. 3A, an example printhead module 202 includes an electronics assembly 206, an ink/air system 210, an alignment assembly 214, and a printhead assembly 218. In various implementations, the printhead assembly may include 128 nozzles. The nozzles receive fluid manufacturing material, solvent, air pressure, and vacuum from the ink/air system 210.

The electronics assembly 206 controls which of these inputs is applied to the printhead assembly 218. For example, the electronics assembly 206 may actuate valves of the ink/air system 210 to allow solvent to reach the printhead assembly.

The electronics assembly 206 may also control the alignment assembly 214. The electronics assembly 206 may communicate with an alignment module. For example only, this communication may occur over a controller area network (CAN) bus. The alignment module may determine whether alignment of the nozzles in the printhead assembly 218 matches a desired alignment.

For example only, the alignment module may include a camera facing up at the printhead assembly 218. The alignment module may use the camera to determine whether adjustments need to be made by the alignment assembly 214. These adjustments are communicated to the electronics assembly 206, which drives actuators of the alignment assembly 214 to adjust the printhead assembly 218.

For example, the camera may determine the height of the printhead assembly 218 relative to the substrate. The alignment module may determine height based on a lens position that brings the nozzle into focus. The alignment module may instruct the electronics assembly 206 to drive the alignment assembly 214 to achieve a desired height of the printhead assembly 218. For example only, a uniform height may be set for all of the printhead modules in the microdeposition system.

The alignment module may also determine the spacing between the nozzles of the printhead assembly 218. For example only, while spacing between each of the nozzles in the printhead assembly 218 may be uniform, that spacing may vary between different printhead assemblies. FIG. 3B depicts a mechanism for realizing a standard nozzle spacing by rotating the printhead assembly 218 around the z axis. Further, the alignment module may align the printhead assembly 218 with printhead assemblies of other printhead modules in the pack with respect to the x axis. The reason for this is shown in FIG. 3C.

Referring now to FIG. 3B, a top view of the nozzles of a printhead assembly 250 is shown. For purposes of illustration, four nozzles are depicted. The distance between the first and last nozzle is d₀ and the spacing between each nozzle is therefore d₀ divided by three. If the spacing between the nozzles is too great, the printhead assembly can be rotated, such as is shown at 254. With respect to the x axis (i.e., with nozzle positions projected onto the x axis), the distance between the first and last nozzles is now d₁, which is less than d₀. The effective nozzle spacing is now d₁ divided by three.

As seen in FIG. 3B, rotating the printhead assembly 250 can decrease the nozzle spacing, but cannot increase the nozzle spacing. Therefore, the nozzle spacing of all of the printhead assemblies of a microdeposition system may be set equal to the smallest spacing of any one of the printhead assemblies. While the printhead assembly 254 is shown rotated at a 45 degree angle for purposes of illustration, actual rotation angles may be much smaller.

Rotation of the printhead assembly for a printhead module is performed by the respective alignment assembly for that printhead module while the printhead module itself remains stationary. This is performed in order to achieve a nozzle spacing that is uniform for all of the printhead modules, which may be done as part of an initial calibration process, such as whenever a printhead module is added or removed from a pack. By contrast, the procedure described with respect to FIG. 2 rotates all of the packs of printhead modules as a group using the printhead carriage 104. This rotation may be performed once the printhead modules are adjusted individually, and the rotation may be based on the feature pattern to be printed.

Referring now to FIG. 3C, an example of two packs, each including two printhead modules having four nozzles each, is shown for purposes of illustration. Gaps may be present between the printhead modules of a pack because of the space requirements of mechanical, electrical, and fluidic components of the printhead module. The distance between the nozzle plates of the two printhead modules may be designed to be approximately equal to the length of one of the nozzle plates.

The second pack may therefore be staggered with respect to the first pack so that the nozzles of the second pack line up with the gaps between the printhead modules of the first pack. Each of the printhead modules may be individually translated with respect to the x axis to accurately align the modules of each pack with each other. With respect to the x axis, the combined nozzles of the first and second packs then have a uniform spacing. Similar to the spacing adjustment described in FIG. 3B, the x axis alignment may be performed as part of a calibration process.

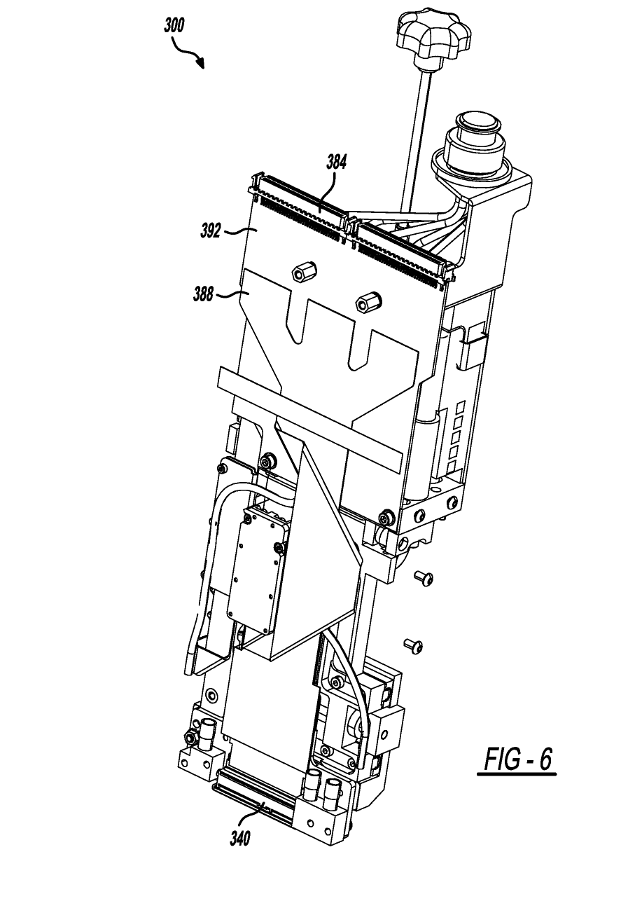

Referring now to FIG. 4, an example implementation of a printhead module 300 includes a rear cover 304 and a datum mounting block 308. The datum mounting block 308 includes openings 312 that fit into projections of a pack mounting block (not shown). The datum mounting block 308 seats against the pack mounting block, which establishes a position in the z axis of the printhead module 300. Because the datum mounting block 308 seats firmly against a flat surface of the pack mounting block, rotation of the printhead module 300 about the y axis is limited.

The openings 312 in the datum mounting block 308 are closely matched to the sizes of projections of the pack mounting block to prevent movement of the printhead module 300 along the y axis. In addition, this matching limits rotation of the printhead module 300 around the z axis. Further, a flat-faced datum bracket 316 may sit against a corresponding face of the pack mounting block, further establishing the y axis position of the printhead module 300.

A projection 320 of the datum bracket 316 may insert into a corresponding opening of the pack mounting block. Combined with the mechanical connections at the openings 312, the projection 320 prevents rotation of the printhead module 300 around the x axis. A locking rod 324, which may be turned using a handle 328, engages a threaded tip 332 into the pack mounting block. This secures the printhead module 300 and forces the datum mounting block 308 against the pack mounting block. In various implementations, the opening of the pack mounting block that receives the projection 320 and the projections of the pack mounting block that are received by the openings 312 may include spring-loaded bearings or bearing surfaces to ensure a tight fit.

Pins 314 may extend down from the datum mounting block 308. The pins may fit into corresponding voids in the pack mounting block. The voids in the pack mounting block may be oval channels that each have an x axis dimension approximately equal to the diameter of the pins 314 and have a y axis dimension greater than the diameter of the pins 314. The voids in the pack mounting block therefore do not constrain the pins 314 in the y axis direction, but do establish the x axis location of the datum mounting block 308. The pins 314 therefore allow the x axis tolerances of the openings 312 and the projection 312 to be relaxed.

An inkjet printhead assembly 340 is mounted to an alignment bracket 344. The alignment bracket 344 is adjusted using an alignment mechanism 348 described in more detail below. The printhead assembly 340 may include piezoelectric transducers to selectively fire droplets of a fluid manufacturing material. Fluid lines are connected to the printhead module 300 via a fluid port 360, which may allow rapid connection of multiple fluid lines.

Referring now to FIG. 5, removal of the rear cover 304 reveals a printed circuit board 364 (individual traces and components not shown), which may include communication circuitry, motor drive circuitry, sensor circuitry, and fluid valve control circuitry. Power and communication signals may be received at an input connector 368. The communication signals may include networking signals, which for example may comply with the IEEE 802.3 standard. A sensor input connector 372 may receive signals from one or more fluid sensors, which may monitor fluid levels of a reservoir. A motor connector 376 may control one or more actuators of the alignment mechanism 348. A solenoid connector 380 provides control signals to fluid control valves.

Referring now to FIG. 6, an input connector 384 receives drive signals for the nozzles of the printhead assembly 340. These signals are communicated to the printhead assembly 340 by a flexible circuit 388. An adapter 392 may interface between the flexible circuit 388 and the input connector 384. In various implementations, the flexible circuit 388 may be provided by the manufacturer of the printhead assembly 340.

In various implementations, the input connector 384 may include a signal pin for each of the nozzles of the printhead assembly 340. Firing waveforms are received at the input connector 384 from an outside drive control module. The input connector 384 may also include a signal return pin for each of the nozzles of the printhead assembly 340.

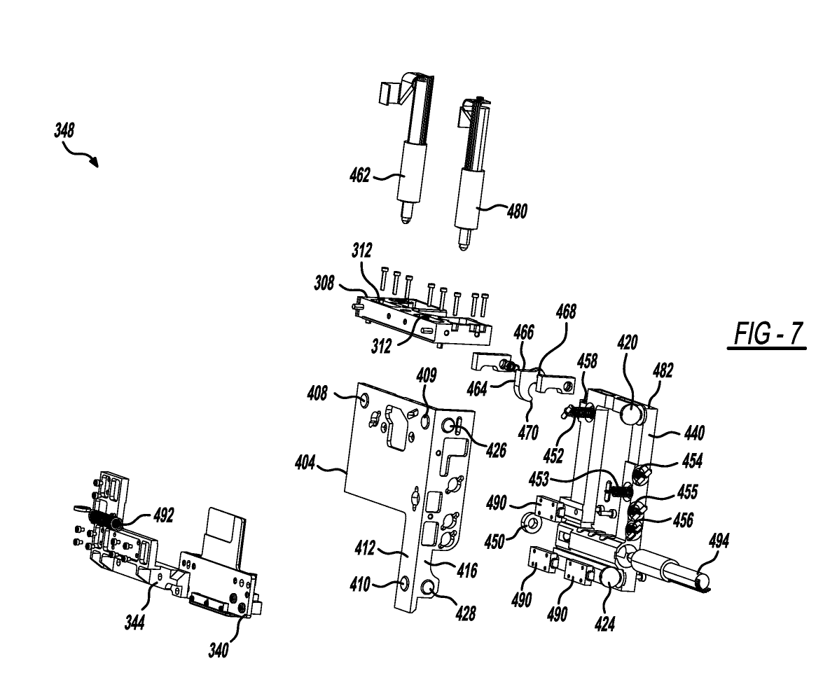

Referring now to FIG. 7, the datum mounting block 308 serves as a reference point when secured to the pack mounting block (not shown). A datum bracket 404 is rigidly secured to the datum mounting block 308. The datum bracket 404 may include datum pads 408, 408, and 410, which seat against a flat surface of the pack mounting block. The datum pads 408, 409, and 410 may therefore establish the y axis position of the datum bracket 404.

The datum bracket 404 is formed from a rigid material and includes a first portion 412 and a second portion 416 that is perpendicular to the first portion 412. The outside corner formed by the portions 412 and 416 is visible in FIG. 7. On the inside corner, datum pads are mounted on both the first and second portions 412 and 416. Spherical pivots 420 and 424 are pressed against these datum pads by a rotating bracket 440.

In various implementations, the datum pads 408, 409, and 410, extend through the first portion 412 to serve as datum pads on the other side of the datum bracket 404. The datum pads 409 and 410 therefore have one side that seats against the pack mounting block while the other side supports the pivots 420 and 424. In this way, the y axis orientation of the rotating bracket 440 is determined directly from the pack mounting block.

Datum pads 426 and 428 support the pivots 420 and 424, and are visible in FIG. 7 because the datum pads 426 and 428 extend through the second portion 416. The datum pads 409, 410, 426, and 428 may have a contact surface large enough to allow the z position of the pivots 420 and 424 to change, as described in more detail below.

The rotating bracket 440 rotates about the pivots 420 and 424. Washers, such as a spherical pivot washer 450, may be located between the pivots 420 and 424 and the rotating bracket 440. The washers may retain the pivots 420 and 424 and prevent them from rolling out of position. The rotating bracket 440 is held in place against the datum bracket 404 by springs 452, 453, 454, 455, and 456.

In order to rotate the rotating bracket 440, a force can be applied to the rotating bracket 440 on a side opposite from the pivots 420 and 424. For example, applying force against a projection 458 rotates the rotating bracket 440 about the z axis. The force applied to the projection 458 may be applied by an actuator 462, which may be a linear actuator. In various implementations, linear actuators having an accuracy of 0.5 microns may be used.

The actuator 462 may be mounted to the datum mounting block 308 in a vertical orientation. Vertical operation of the actuator 462 may be translated into horizontal force against the projection 458 by a rocker arm 464. A tip of the actuator 462 may press on the rocker arm 464 at a contact point 466. The rocker arm 464 may rotate about a rod inserted through a hole 468 and apply pressure to the projection 458 with an engagement point 470.

Another actuator 480 may be mounted to the datum mounting block 308 in a vertical orientation. The actuator 480 may apply a force along the z axis to the rotating bracket 440. The pressure may be applied to the rotating bracket 440 at a contact point 482. The actuator 480 therefore translates the rotating bracket 440 along the z axis. Because pressure is applied in line with the pivots 420 and 424, movement along the z axis should not change the angle about the z axis of the rotating bracket 440. The pivots 420 and 424 are able to roll along the datum pads 409, 410, 426, and 428 to the new position along the z axis.

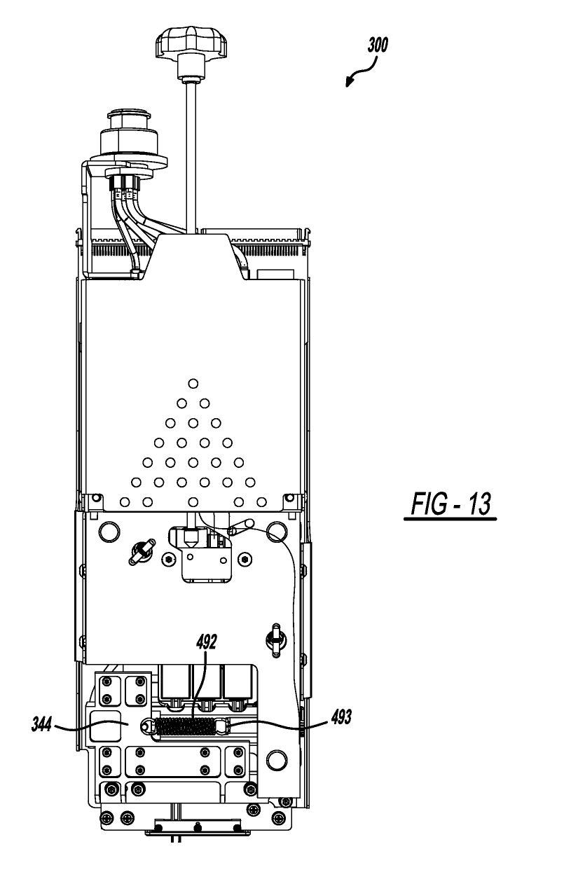

The alignment bracket 344 rigidly retains the printhead assembly 340. The alignment bracket 344 attaches to the rotating bracket 440 via linear slides 490. The alignment bracket 344 can therefore slide along the rotating bracket 440 in the x axis direction. The alignment bracket 344 is forced to one end of its x axis travel by a spring 492. One end of the spring 492 attaches to the alignment bracket 344 and an opposite end of the spring 492 attaches to the rotating bracket 440, such as at projection 493 (see FIG. 13). An actuator 494 oriented in the x axis direction moves the alignment bracket 344 against the force of the spring 492. The printhead assembly 340 can therefore be adjusted in the theta z, z, and x directions by the actuators 462, 480, and 494, respectively.

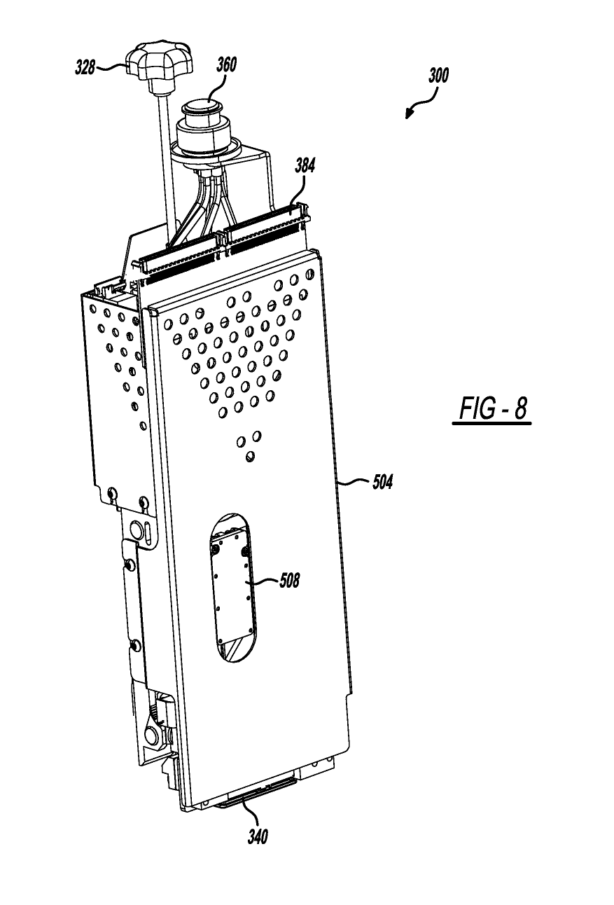

Referring now to FIG. 8, a protective front cover 504 may have an opening to allow access to a removable filter assembly 508. The filter assembly 508 may filter out contaminants before they have an opportunity to cause flow problems with the nozzles in the printhead assembly 340.

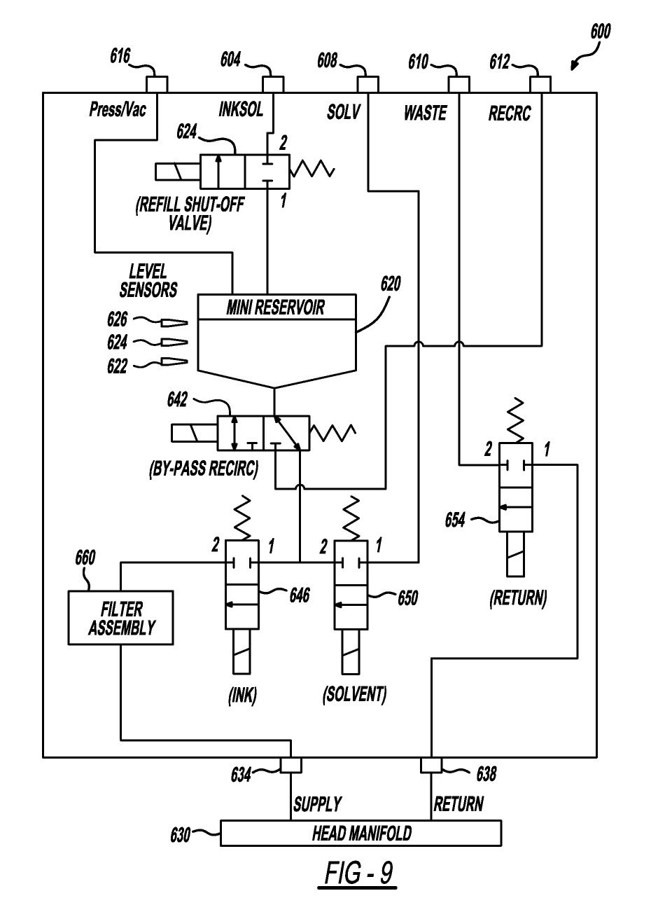

Referring now to FIG. 9, a functional block diagram of a fluid system 600 of the printhead module 300 is presented. An ink/solvent port 604 receives either ink or solvent from an external fluid supply module (not shown). A solvent port 608 receives solvent from the external fluid supply module. A waste port 610 provides waste material to an external waste station. A recirculation port 612 provides returns ink back to the fluid supply module.

A pressure or a vacuum can be applied at a pressure/vacuum port 616. Ink or solvent is supplied to a reservoir 620 from the ink/solvent port via an optional shutoff valve 624. The reservoir 620 may include a low sensor 622, a full sensor 624, and an overflow sensor 626. These sensors sense the level of fluid within the reservoir 620.

When the level of the fluid decreases below the full sensor 624, fluid may be provided to the reservoir 620 until the overflow sensor 626 is reached. At this point, supply of the fluid from the external fluid supply module is stopped. The shutoff valve 624 may be actuated to prevent the reservoir 620 from overfilling while the external fluid supply module is shutting off. If the level of fluid drops below the low sensor 622, printing may be stopped.

In various implementations, the reservoir 620 may be formed from tubing, such as 18 millimeter diameter polytetrafluoroethylene tubing. A bottom surface of the reservoir 620 may be tapered to prevent solid material from collecting in corners of the tubing, such as when spacer molecules suspended in solvent are being printed.

A head manifold 630 may supply fluid to each of the nozzles of the printhead module 300. The head manifold 630 may include a supply port 634 and a return port 638. An output of reservoir 620 is connected to a recirculation valve 642. The recirculation valve 642 directs fluid from the reservoir either to the recirculation port 612 or to an ink valve 646.

When the recirculation valve 642 directs ink to the recirculation port 612, ink can continuously flow into the reservoir 620 and out of the recirculation port 612. This prevents molecules held in suspension from settling when the printhead module 300 is not printing. For example, recirculation may be used while substrates are loaded and unloaded.

The ink valve 646 selectively allows ink to reach the supply port 634. In various implementations, the ink valve 646 may be absent. The ink valve 646 may also receive solvent from a solvent valve 650. The solvent valve 650 selectively allows solvent from the solvent port 608 to reach the ink valve 646. Solvent from the solvent port 608 may be used to clean the nozzles to correct printing problems, while solvent from the ink/solvent port 604 may be used to flush the reservoir 620 in preparation for printing with new ink. A return valve 654 selectively allows fluid from the return port 638 to leave the waste port 610. The return valve 654 may also open to allow air to quickly escape from the head manifold 630.

The pressure/vacuum port 616 is connected to the reservoir 620. Pressure may be applied to force solvent and/or ink through the supply port 634 into the head manifold 630, such as when cleaning the head manifold 630, cleaning the nozzles, and/or replacing one fluid with another. For example only, a pressure of 5 psi may be applied for one second to produce a puff of ink from the nozzles. Pressure may also be used to eject ink onto a blotting material. The blotting material may be wiped across the face of the nozzle to remove contamination and/or dried ink. For example only, 1.5 milliliters of ink may be deposited on the blotting material.

When filling the head manifold 630, the nozzles may be pulsed at 5 kHz to agitate the ink and allow small channels in the head manifold 630 and the nozzles to fill with ink faster. A small amount of vacuum may be applied to the reservoir 620 to counteract the static head of the fluid, which may be provided from a location above the reservoir 620. For example, a vacuum may be pulled to counteract approximately 8 inches of static head.

In addition, a negative miniscus may be formed at the nozzles by applying further negative pressure to the reservoir 620. This negative pressure may be two inches of vacuum, for example. A negative miniscus may allow droplets to be formed more evenly and at a more deterministic time. A filter assembly 660 may remove contaminants from the fluid prior to the fluid reaching the head manifold 630. For example only, the filter assembly 660 may be located between the ink valve 646 and the supply port 634.

In various implementations, ink may be recirculated through the head manifold 630. In such a case, the recirculation valve 642 may be located between the return port 638 and the return valve 654. During recirculation, the recirculation valve 642 would route fluid from the return port 638 to the recirculation port 612. Otherwise, the recirculation valve 642 would route fluid from the return port 638 to the waste port 610. In such an implementation, the solvent valve 650 may be located between the solvent port 608 and the supply port 634. Outputs of the ink valve 646 and the solvent valve 650 would therefore join at the supply port 634.

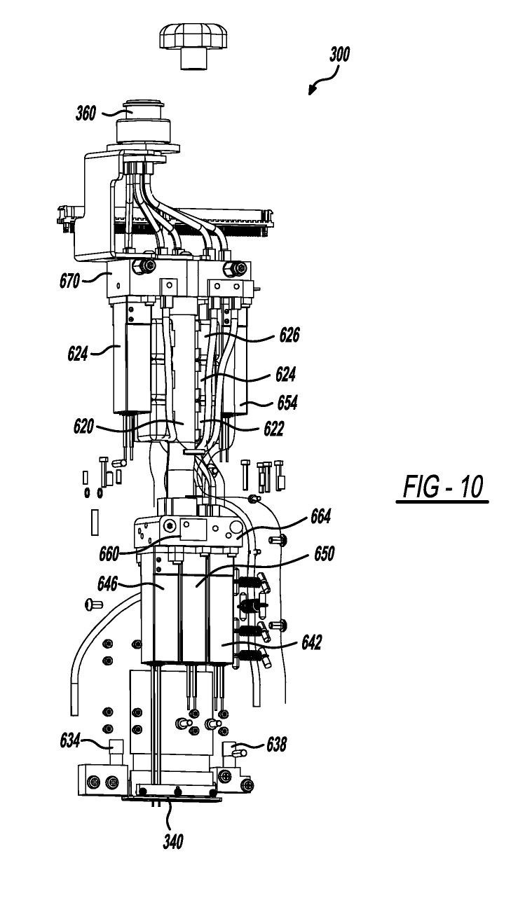

Referring now to FIG. 10, a perspective view of the printhead module 300 is shown. The filter assembly 660 may be removable so that the filter can be cleaned and/or replaced. The filter assembly 660 may be part of a lower manifold 664. The lower manifold 664 may serve as a mounting surface for three valves, such as the ink valve 646, the solvent valve 650, and the recirculation valve 642.

The lower manifold 664 may provide channels to route fluid between the connected valves. For example, the lower manifold 664 may implement some of the fluid routes shown in FIG. 9. An upper manifold 670 may provide a similar function. The upper manifold 670 may serve as a mounting surface for the shutoff valve 624 and the return valve 654. In addition, the upper manifold 670 may receive fluid lines from the fluid port 360, which may be a quick disconnect port. The reservoir 620 may be connected between the upper manifold 670 and the lower manifold 664. The level sensors 622, 624, and 626 may wrap partially or fully around the reservoir 620.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A microdeposition system comprising:
a printhead carriage that includes N printhead modules and that moves along an x axis, wherein N is an integer greater than one;
a stage that holds a substrate beneath the printhead carriage and that moves the substrate along a y axis perpendicular to the x axis,
wherein each of the N printhead modules includes:
a fixed bracket rigidly mounted to the printhead carriage;
a rotating bracket rotatably and slidably coupled to the fixed bracket, wherein the rotating bracket rotates about a z axis perpendicular to a horizontal plane parallel to the x and y axes, and slides along the z axis;
a first actuator that rotates the rotating bracket with respect to the fixed bracket;
a second actuator that slides the rotating bracket relative to the fixed bracket;
a printhead bracket slidably coupled to the rotating bracket, wherein the printhead bracket slides along the x axis when the rotating bracket is parallel to the x axis;
a third actuator that slides the printhead bracket relative to the rotating bracket,
a printhead rigidly attached to the printhead bracket, wherein the printhead includes a plurality of nozzles separated from each other by a physical nozzle spacing and arranged along a line parallel to the horizontal plane, wherein the plurality of nozzles deposit droplets of fluid material onto the substrate; and
a controller that controls the first actuator of each of the N printhead modules to set an effective nozzle spacing of the N printhead modules to a common spacing value, wherein the effective nozzle spacing is defined by spacing between positions of the plurality of nozzles as projected onto the x axis, wherein:
the controller selectively adjusts the third actuator of first and second printhead modules of the N printhead modules such that an effective spacing between a last nozzle of the first printhead module and a first nozzle of the second printhead module, with respect to the x axis, is equal to the common spacing value,
the common spacing value is determined based on a minimum one of the physical nozzle spacings of the N printhead modules,
the controller controls the second actuator of each of the N printhead modules to set a vertical position of each of the N printhead modules to a common vertical value,
the printhead carriage includes a turntable that holds the N printhead modules, and
the turntable rotates with respect to the printhead carriage about the z axis.

2. A microdeposition system comprising:
a stage that holds a substrate;
a printhead carriage that includes N printhead modules, wherein N is an integer greater than one, and wherein each of the N printhead modules includes:
a printhead including a plurality of nozzles that deposit droplets of fluid manufacturing material onto the substrate while relative movement between the substrate and the printhead is along a first axis; and
an alignment mechanism that adjusts the printhead with respect to the printhead module; and
a controller that controls the alignment mechanisms of the N printhead modules to set effective nozzle spacing for the pluralities of nozzles to a uniform value, wherein the effective nozzle spacing is defined as spacing between adjacent ones of the plurality of nozzles as projected onto a second axis perpendicular to the first axis.

3. The microdeposition system of claim 2 wherein the stage moves the substrate along the first axis during deposition of the droplets of fluid manufacturing material, and wherein the printhead carriage translates to new positions along the second axis between passes of the substrate.

4. The microdeposition system of claim 2 wherein, for each of the N printhead modules, the plurality of nozzles are separated by a physical nozzle spacing, and wherein the controller determines the uniform value based on the physical nozzle spacings of the N printhead modules.

5. The microdeposition system of claim 4 wherein the controller determines the uniform value based on a smallest one of the physical nozzle spacings of the N printhead modules.

6. The microdeposition system of claim 4 further comprising a camera facing toward the printhead carriage along a third axis perpendicular to the first and second axes, wherein the controller determines the physical nozzle spacing of each of the N printhead modules based on information from the camera.

7. The microdeposition system of claim 2 wherein the controller controls the alignment mechanism of one of the N printhead modules to set the effective nozzle spacing for the plurality of nozzles of the one of the N printhead modules to the uniform value.

8. The microdeposition system of claim 7 wherein the alignment mechanism of the one of the N printhead modules comprises:
a fixed bracket mounted to the printhead carriage;
a rotating bracket rotatably coupled to the fixed bracket, wherein the printhead is coupled to the rotating bracket; and
an actuator that, based on control from the controller, rotates the rotating bracket about a third axis perpendicular to the first and second axes.

9. The microdeposition system of claim 2 wherein the controller controls the alignment mechanisms of first and second adjacent printhead modules of the N printhead modules to set the effective nozzle spacing between a last nozzle of the first adjacent printhead module and a first nozzle of the second adjacent printhead module to the uniform value.

10. The microdeposition system of claim 9 wherein the N printhead modules are arranged in a plurality of rows that are parallel to the second axis, wherein the first adjacent printhead module is in a first one of the plurality of rows, and wherein the second adjacent printhead module is in a second one of the plurality of rows.

11. The microdeposition system of claim 9 wherein the alignment mechanism of the second adjacent one of the N printhead modules comprises:
a bracket coupled to the printhead carriage;
a printhead assembly slidably coupled to the bracket, wherein the printhead is mounted to the printhead assembly, and wherein the printhead assembly slides along the second axis when the bracket is parallel to the second axis; and
an actuator that, based on control from the controller, slides the printhead assembly with respect to the bracket.

12. The microdeposition system of claim 2 wherein for each of the N printhead modules, the alignment mechanism adjusts the printhead along a third axis perpendicular to the first and second axes, and wherein the controller sets a spacing between the printhead and the stage to a common height for each of the N printhead modules.

13. The microdeposition system of claim 12 further comprising a camera facing toward the printhead carriage along the third axis, wherein the controller controls the alignment mechanism of the N printhead modules based on a focal length measurement of the respective one of the N printhead modules by the camera.

14. The microdeposition system of claim 13 wherein the alignment mechanism of one of the N printhead modules includes:
a fixed bracket mounted to the printhead carriage;
a second bracket slidably coupled to the fixed bracket along the third axis, wherein the printhead is coupled to the second bracket; and
an actuator that, based on control from the controller, slides the second bracket with respect to the fixed bracket.

15. The microdeposition system of claim 2 wherein the alignment mechanism for one of the N printhead modules includes:
a fixed bracket mounted to the printhead carriage;
a rotating bracket rotatably coupled to the fixed bracket, wherein the rotating bracket rotates about a third axis perpendicular to the first and second axes, and wherein the printhead is coupled to the rotating bracket; and
a first actuator that rotates the rotating bracket relative to the fixed bracket.

16. The microdeposition system of claim 15 wherein the printhead is slidably coupled to the rotating bracket, wherein the printhead slides along the second axis when the rotating bracket is parallel to the second axis, and wherein the alignment mechanism for one of the N printhead modules further includes a second actuator that slides the printhead with respect to the rotating bracket.

17. The microdeposition system of claim 16 wherein the rotating bracket is slidably coupled to the fixed bracket, and wherein the alignment mechanism for one of the N printhead modules further includes a third actuator that slides the rotating bracket along the third axis with respect to the fixed bracket.

18. The microdeposition system of claim 2 wherein the printhead carriage includes a turntable that holds the N printhead modules, and wherein the turntable rotates with respect to the printhead carriage about a third axis perpendicular to the first and second axes.

19. The microdeposition system of claim 2 wherein the controller performs a calibration routine to set the effective nozzle spacing for the pluralities of nozzles to the uniform value before depositing the droplets of fluid manufacturing material onto the substrate has begun.

20. A printhead module comprising:
a printhead including a plurality of nozzles that deposit droplets of fluid manufacturing material onto a substrate;
a head manifold that distributes the fluid manufacturing material to the plurality of nozzles and that includes a supply port and a return port; and
a fluid distribution system that connects to the supply port and the return port and that includes:
a pressure port that receives one of a pressure and a vacuum;
a reservoir having a cylindrical shape with a tapered bottom portion, wherein the pressure port applies the one of the pressure and the vacuum to a top of the reservoir;
an ink port that receives one of the fluid manufacturing material and a solvent;
a refill valve that selectively connects the ink port to the reservoir;
fluid sensors that measure levels of fluid in the reservoir;
a control module that controls the refill valve based on the measured levels of fluid;
a recirculation port that returns unused amounts of the fluid manufacturing material to an external fluid supply;
a bypass valve that alternately connects the reservoir to a common fluid node and to the recirculation port;
a solvent port that receives the solvent;
a solvent valve that selectively connects the solvent port to the common fluid node;
an ink valve that selectively connects the common fluid node to the supply port;
a removable filter assembly interposed between the ink valve and the supply port;
a waste port; and
a return valve that selectively connects the return port to the waste port.
